(19) United States
(12) Patent Application Publication
(10) Pub. No.: US 2017/0334300 A1
(43) Pub. Date: Nov. 23, 2017

(54) Charging System with Temperature Sensor

(71) Applicant: Faraday&Future Inc., Gardena, CA (US)

(72) Inventors: Jason Huang, Fremont, CA (US); Boaz Jie Chai, Mountain View, CA (US)

(73) Assignee: Faraday&Future Inc., Gardena, CA (US)

(21) Appl. No.: 15/160,904

(22) Filed: May 20, 2016

(51) Int. Cl. B60L 11/18; H02J 7/00

(52) U.S. Cl. CPC B60L 11/1818; H02J 7/007; H02J 7/0029; H02J 7/0045

(57) ABSTRACT

A charging system may include a plug adapter for receiving a charging current and a processor configured to receive data from the plug adapter. The plug adapter may include a thermal sensor configured to measure temperature associated with the plug adapter. The processor may be configured to decrease the charging current if the temperature measured by the thermal sensor exceeds a first threshold temperature. The processor may be further configured to turn off the charging current if the temperature measured by the thermal sensor exceeds a second threshold temperature.

### TECHNICAL FIELD

The present disclosure relates generally to a charging system, and more particularly, to a charging system including a temperature sensor.

### BACKGROUND

Vehicles that are at least partially powered by electricity, such as electric vehicles and hybrid vehicles, must be periodically charged. These vehicles may draw current from dedicated charging stations or from home or commercial outlets. Often, the vehicles are connected to these power sources by charging systems, which may include electric vehicle supply equipment (EVSE) and plug adapters.

Because of the high voltage and current used for the charging systems, they require monitoring to ensure that they remain safe and effective. For example, the resistive components, such as metal contacts, used in the charging system may convert electric power to heat. If components such as the plug adapter become overheated, there may be a risk of short circuit, melting, and sometimes fire. Existing charging systems do not have sufficient mechanisms to detect or solve the overheating issue.

The charging system disclosed herein is directed to mitigating or overcoming one or more of the problems set forth above and/or other problems in the prior art.

### SUMMARY

One aspect of the present disclosure is directed to a charging system. The charging system may include a plug adapter for receiving a charging current and a processor configured to receive data from the plug adapter. The plug adapter may include a thermal sensor configured to measure temperature associated with the plug adapter. The processor may be configured to decrease the charging current if the temperature measured by the thermal sensor exceeds a first threshold temperature. The processor may be further configured to turn off the charging current if the temperature measured by the thermal sensor exceeds a second threshold temperature.

Another aspect of the present disclosure is directed to a method of charging. The method may include measuring a temperature associated with a plug adapter for receiving a charging current. The plug adapter may include a thermal sensor configured to measure the temperature. The method may further include providing data including the temperature measurement to a processor. The method may also include causing, by the processor, the charging current to decrease if the temperature measure by the thermal sensor exceeds a first threshold temperature. And the method may further include causing, by the processor, the charging current to turn off if the temperature measured by the thermal sensor exceeds a second threshold temperature.

Yet another aspect of the present disclosure is directed to a charging system for an electric vehicle. The charging system may include a plug adapter for receiving a charging current. The plug adapter may include a thermal sensor configured to measure a temperature associated with the plug adapter. The charging system may further include an electric vehicle supply equipment (EVSE), which may include a processor. The processor may be configured to receive data from the plug adapter. The processor may be configured to decrease the charging current if the temperature measured by the thermal sensor exceeds a first threshold temperature. The processor may be further configured to turn off the charging current if the temperature measured by the thermal sensor exceeds a second threshold temperature.

### BRIEF DESCRIPTION OF THE DRAWINGS

FIG. 1 is a diagrammatic illustration of an exemplary charging system.

FIG. 2 is a diagrammatic illustration of a lateral view of an exemplary plug adapter that may be used with the exemplary charging system of FIG. 1.

FIG. 3 is a diagrammatic illustration of a lateral view of a second exemplary plug adapter that may be used with the exemplary charging system of FIG. 1.

FIG. 4 is a diagrammatic illustration of a front view of an exemplary plug adapter that may be used with the exemplary charging system of FIG. 1.

FIG. 5 is a cut-away diagrammatic illustration of an exemplary plug adapter that may be used with the exemplary charging system of FIG. 1.

FIG. 6 is a flow-chart depicting an exemplary method performed by the exemplary charging system of FIG. 1.

FIG. 7 is a chart illustrating a first exemplary current versus temperature profile that may be used by the exemplary charging system of FIG. 1, according to an exemplary embodiment of the disclosure.

FIG. 8 is a chart illustrating a second current versus temperature profile that may be used by the exemplary charging system of FIG. 1, according to an exemplary embodiment of the disclosure.

### DETAILED DESCRIPTION

The disclosure is generally directed to a charging system that may be used to safely charge a vehicle. In some embodiments, the charging system may include a plug adapter that may include a thermal sensor configured to measure the temperature associated the plug adapter. A processor receiving data from the thermal sensor may control the magnitude of charging current received by the plug adapter in order to prevent overheating of the charging system. The processor may cause the charging current to decrease or to turn off if the temperature measurements from the thermal sensor exceed threshold temperatures. In some embodiments, the processor generates a warning to a user if the threshold temperatures are repeatedly exceeded.

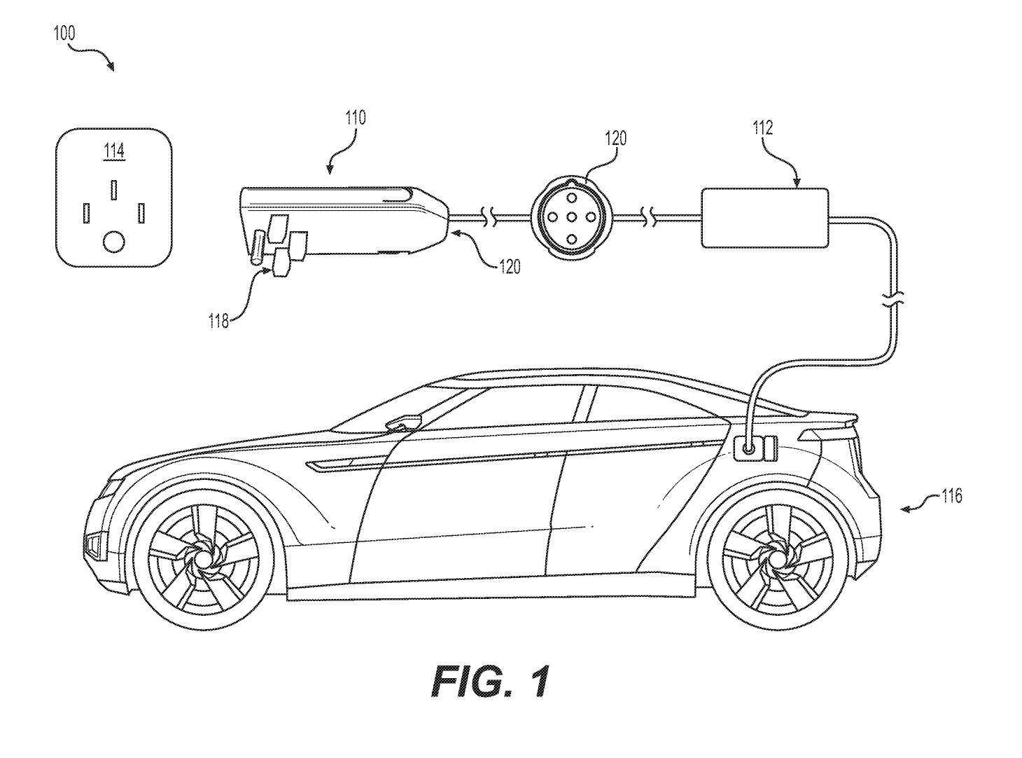

FIG. 1 is a diagrammatic illustration of an exemplary embodiment of an exemplary charging system 100. Charging system 100 may include plug adapter 110 and EVSE 112. In exemplary embodiments, plug adapter 110 may draw a charging current from socket 114, and may be used to charge a vehicle 116. Vehicle 116 may be at least partially powered by electricity. It is contemplated that charging system 100 may also be used to charge other devices (not shown) that are at least partially powered by electricity, such as electric motorcycles, electric bicycles, portable appliances, etc. Plug adapter 110 may contain metal components that are more resistive than other portions of charging system 100, and may therefore heat up more quickly.

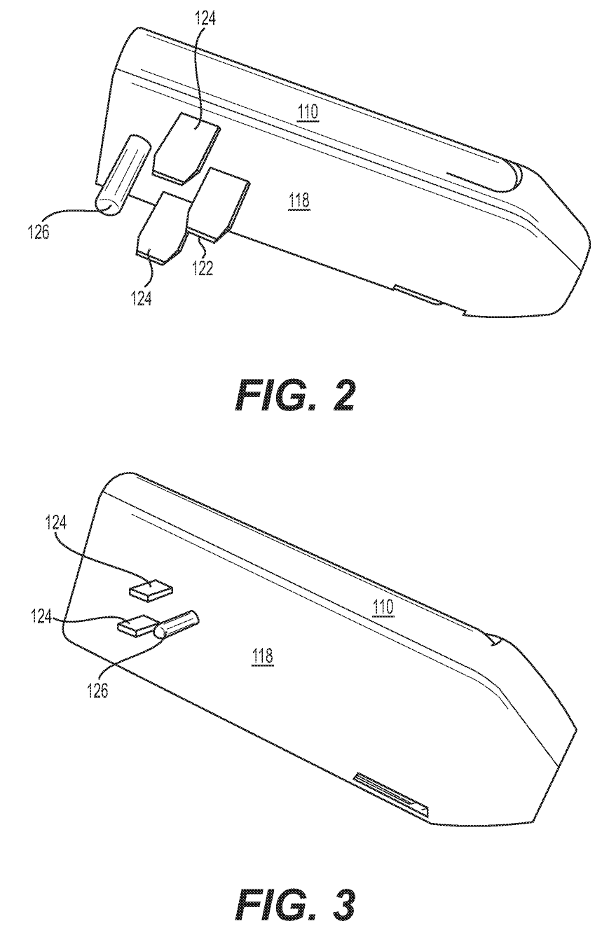

Plug adapter 110 may have a male portion 118 and a female portion 120. Male portion 118 and female portion 120 may be opposite to one another or may be at any angle to one another (e.g., perpendicular to one another, as shown). Male portion 118 may be configured to be received by socket 114, and female portion 120 may be communicatively connected to EVSE 112. Plug adapter 110 is described in greater detail with respect to FIGS. 2, 3, and 4.

EVSE 112 may conform to industry or local charging codes and/or standards. EVSE 112 may include connection ports configured to connect the EVSE to plug adapter 110 and vehicle 116. EVSE 112 may further include electrical wiring, such as circuit interrupters and conductors, configured to facilitate the delivery of electrical energy from power supplies such as socket 114 to electric vehicle 116. EVSE 112 may also include communication cables that facilitate two-way communication between power supplies such as socket 114 and electric vehicle 116. For example, EVSE 112 may be configured to receive data from plug adapter 110 and control the charging current received by vehicle 116. EVSE 112 may include processor 113 to process the data and generate control signals.

Processor 113 may include any appropriate type of general-purpose or special-purpose processor or microprocessor, digital signal processor, or microcontroller. Processor 113 may receive data via a wired connection or wirelessly via, for example, infrared, Bluetooth®, wireless network, radio, or other near-field communication system. Processor 113 may be configured to control the magnitude of the charging current received by plug adapter 110 from socket 114. Processor 113 may be further configured to control a ground fault circuit interrupter.

Socket 114 may be an interior or exterior wall socket in a home or commercial establishment, or may be a specially designed charging socket. Shown in FIG. 1 with four female connections (for example, positive, negative, neutral, and ground), socket 114 may alternatively be, for example, a two-prong or three-prong socket. Socket 114 may be configured to conform to the European, American, or other electrical engineering standards.

In embodiments directed to vehicle charging, vehicle 116 may be an electric or hybrid vehicle, cycle, scooter, motorcycle, or the like. Vehicle 116 may have any style of body, such as a sports car, a coupe, a sedan, a pick-up truck, a station wagon, a sports utility vehicle (SUV), a minivan, or a conversion van.

FIGS. 2, 3, and 4 are diagrammatic illustrations of exemplary plug adapters 110. Plug adapter 110 may be composed of plastic, ceramics, or other known materials. Plug adapter 110 may be of different shapes and dimensions based at least in part on convenience and the particular charging system requirements.

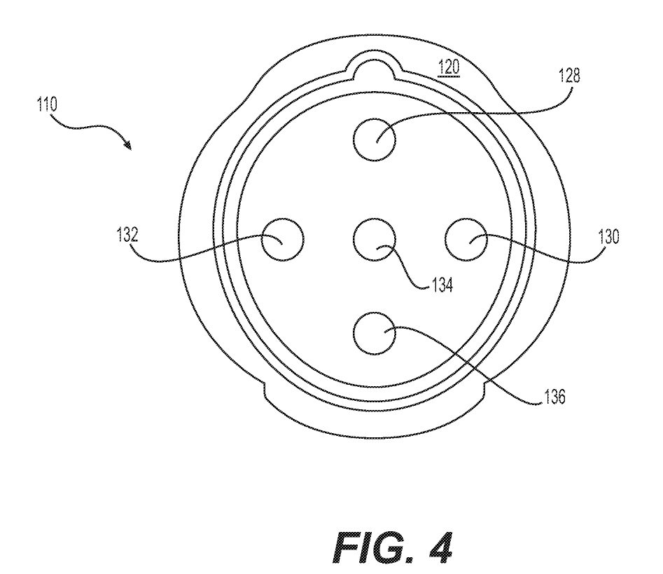

As discussed, and as depicted in FIG. 2, plug adapter 110 may have male portion 118, which may be configured to be received by socket 114. Male portion 118 may include two “hot” (i.e., live current) prongs 124, a neutral prong 122, and a ground 126. It is contemplated however that male portion 118 may have any suitable number of prongs and any different configurations in order to be received in a variety of socket types. For example, FIG. 3 shows a different embodiment of plug adapter 110 that includes just the two “hot” prongs 124 and a ground 126.

As seen in FIG. 4, plug adapter 110 may also include female portion 120. Female portion 120 may be communicatively connected to EVSE 112 in order to provide data from plug adapter 110 to EVSE 112, and specifically, to processor 113. In an exemplary embodiment, female portion 120 includes data ports that may be connected to EVSE 112 via a wired connection. For ease of description, five separate data ports configured to receive five cables are depicted, however it is also contemplated that data may be received by EVSE 112 via a single bundled cable or via power-line communication system. It is further contemplated that EVSE 112 may receive some or all data from plug adapter 110 wirelessly via infrared, Bluetooth®, wireless network, radio, or a near-field communication system.

It is contemplated that female portion 120 may include more or fewer ports than those five shown in FIG. 4, and may include, for example, positive 128, negative 130, adapter 132, and ground 134. In addition to these ports, female portion 120 may also include thermal sensor port 136.

Thermal sensor port 136 may be configured to measure and provide data regarding the temperature of the plug adapter 110 to EVSE 112. Thermal sensor port 136 may be connected to a thermal sensor 140.

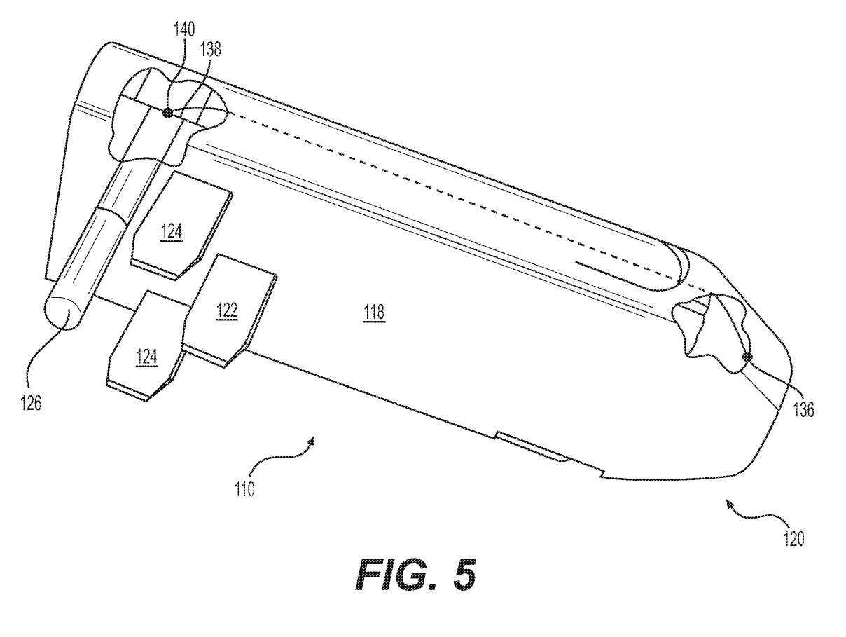

FIG. 5 is a cut-away diagrammatic illustration of an exemplary plug adapter 110 showing thermal sensor 140 connected to thermal sensor port 136. Thermal sensor 140 may be connected to thermal sensor port 136 via cables, wires, or other techniques known in the art. Thermal sensor 140 may be a thermocouple, thermistor (e.g., a thermally sensitive resistor), thermal fuse, or other type of temperature measuring device known in the art. Thermal sensor 140 may be configured to measure the temperature within plug adapter 110.

As depicted, prongs from male portion 118 are received at a joint 138 of contacts within plug adapter 110, which may connect the prongs from male portion 118 and the data ports from female portion 120. Thermal sensor 140 may be connected to joint 138. Alternatively, thermal sensor 140 may be positioned elsewhere in plug adapter 110. In addition, it is contemplated that multiple thermal sensors 140 may be used and they may be positioned at various portions of plug adapter 110 and may be connected to thermal sensor port 136.

Data from thermal sensor 140 may be sent to EVSE 112, and specifically, may be received and processed by processor 113 of EVSE 112. EVSE 112 may receive the data from plug adapter 110 via a connection through thermal sensor port 136 and the cable connected thereto. EVSE 112 may also receive additional data from plug adapter 110, such as information regarding the charging history of the vehicle or other device, the length of time the vehicle or other device has been charging, the amount of current available, and the like. In some embodiments, additional processors may be used to process any additional data.

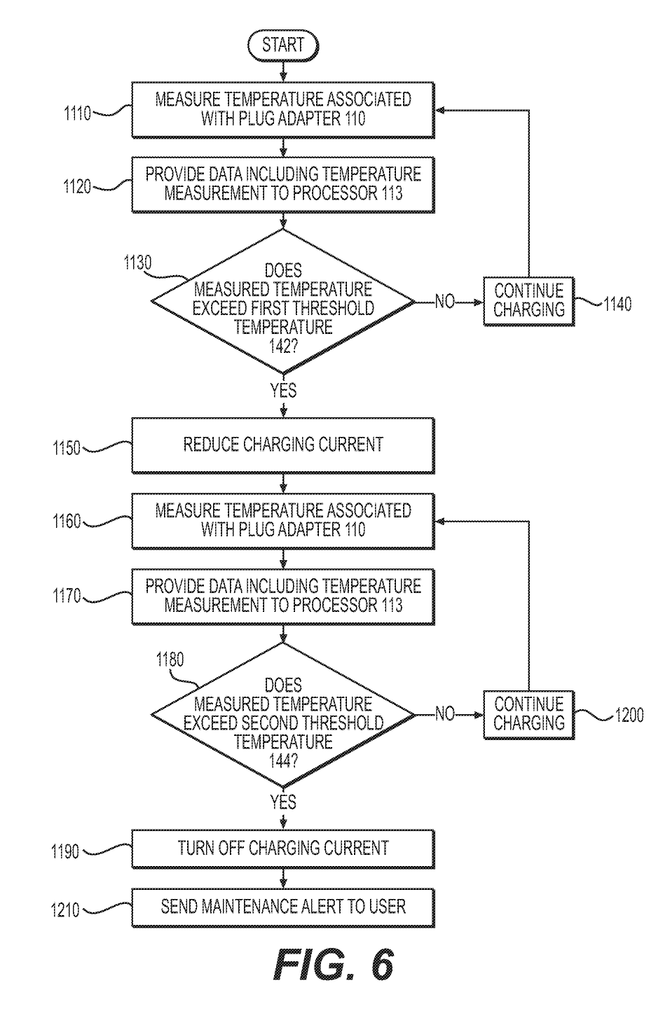

Processor 113 of EVSE 112 may be programmed with one or more threshold temperatures. If the temperature measured by thermal sensor 140 (or, in embodiments employing multiple thermal sensors 140, if the average temperature or maximum temperature measured by the thermal sensors 140) is greater than a first threshold temperature, processor 113 may generate and send a control signal to plug adapter 110 decreasing the charging current drawn by plug adapter 110 from a first charging current. In some embodiments, the first charging current may be determined based on the maximum charging current of the device or vehicle being charged. For example, the first charging current may be 40 A. If the temperature measured by thermal sensor 140 exceeds a second threshold temperature, which may be greater than the first threshold temperature, processor 113 may send a signal to plug adapter 110 and cause the current to turn “off” (e.g., by employing a ground fault circuit interrupter). Consistent with some embodiments, the first threshold temperature may be 105 degrees Celsius and the second threshold temperature may be 160 degrees Celsius. An exemplary process is shown in the flow chart of FIG. 6.

FIG. 6 illustrates the steps of an exemplary method 1000 performed by the exemplary charging system of FIG. 1. After a user connects vehicle 116 to socket 114 via the charging system, charging system 100 starts to monitor the temperature associated with plug adapter 110. For example, in step 1110, thermal sensor 140 measures the temperature. In step 1120, data including the temperature measurement is provided to processor 113. Then, at step 1130, processor 113 may either cause the charging process to continue (step 1140) or may reduce the charging current provided to plug adapter 110 (step 1150), depending on whether the first threshold temperature is exceeded. For example, in step 1130, processor 113 may compare the measured temperature with the first threshold temperature preprogramed in the memory of EVSE 112. If the measured temperature is does not exceed the first temperature threshold (1130: no), processor 113 may determine that overheating does not occur, and continue to have vehicle 116 charged at the ongoing charging current in step 1140. Otherwise, if the measured temperature exceeds the first temperature threshold (1130: yes), processor may determine that an overheating condition may begin to occur. In some embodiments, the first temperature threshold is usually selected as a precaution, at which point the charging current is reduced to a lower level in step 1150, rather than being completely turned off, to prevent the temperature from rising to a hazardous level.

If charging system 100 proceeds to step 1140 and continues to charge, charging system 100 may periodically, e.g., at predetermined intervals, or continuously repeat steps 1110, 1120, and 1130.

If the charging system proceeds to step 1150, charging system 100 continues to measure the temperature associated with plug adapter 110 in step 1160. In step 1170, data including the temperature measurement is provided to processor 113. Processor 113 may then either cause charging to continue (step 1200) if the second threshold temperature is not exceeded, or may turn off the charging current (step 1190) if the second threshold temperature is exceeded. For example, in step 1180, processor 113 may compare the measured temperature with the second threshold temperature preprogramed in the memory of EVSE 112. If the measured temperature is does not exceed the second temperature threshold (1180: no), processor 113 may determine that overheating does not occur, and continue to charge vehicle 116 at the ongoing charging current in step 1200. Otherwise, if the measured temperature exceeds the second temperature threshold (1130: yes), processor 113 may determine that an overheating condition has occurred and turn off the charging current completely in step 1190 to avoid safety hazards.

If charging system 100 continues charging, charging system 100 may again periodically or continuously repeat steps 1160, 1170, and 1180. In exemplary embodiments, if charging system 100 turns off the charging current, processor 113 may send a maintenance alert to a user in step 1210. In some embodiments, the maintenance alert may be an audio signal, e.g., a siren, or a visual signal, such as a warning displayed on a user interface of vehicle 116 (e.g., an internal user interface, an external user interface and/or display screen located on the vehicle). In some embodiments, the maintenance alert may be presented by turning on a maintenance light. The maintenance alert may indicate that plug adaptor 110 and/or EVSE 112 needs to be serviced or replaced.

In some embodiments, the maintenance alert may be sent wirelessly to the user (e.g., to a portable device, user email account, or other user-associated electronic device or account) from processor 113 via near-field communications systems or via the internet. The maintenance alert may also be sent to the device or electric vehicle being charged.

In some embodiments, a maintenance alert may be issued each time the second threshold temperature is exceeded. In other embodiments, processor 113 may track shut-off frequency and send an alert only if the second threshold temperature is exceeded a pre-set number of times.

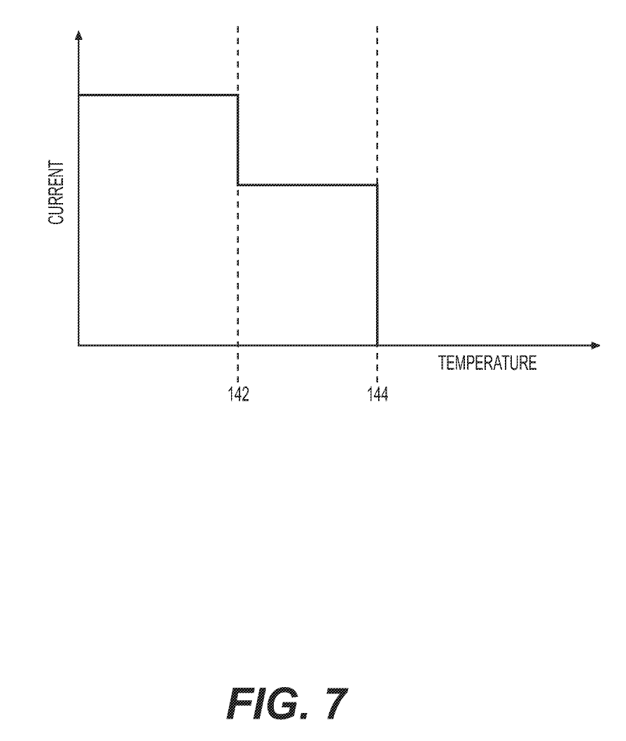

FIG. 7 is a chart illustrating a first exemplary current versus temperature profile that may be used by exemplary charging system 100, according to an exemplary embodiment of the disclosure, as described in FIG. 6. FIG. 7 plots the charging current received by plug adapter 110 against the temperature measured by thermal sensor 140.

As depicted, charging current may initially be provided to plug adapter 110 at a first level. If the temperature of plug adapter 110, as measured by thermal sensor 140 exceeds first threshold temperature 142, processor 113 may decrease the charging current to a second level. If the temperature of plug adapter 110, as measured by thermal sensor 140 continues to rise and/or exceeds second threshold temperature 144, processor 113 may turn the charging current off. If the second threshold temperature 144 is not exceeded, processor 113 may cause the charging current to continue at the second level.

In some embodiments, the first and/or second threshold temperatures may be determined based on a melting point of one or more materials included in plug adapter 110, of connecting cables, and/or other components of charging system 100.

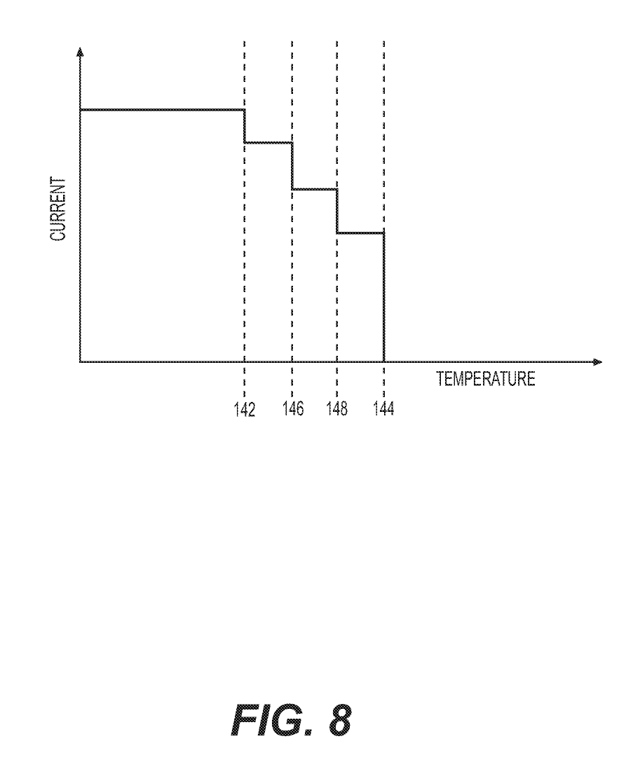

It is contemplated that any number of threshold temperatures may be used. FIG. 8 is a chart illustrating a second current versus temperature profile that may be used by the exemplary charging system, according to an exemplary embodiment of the disclosure.

Like FIG. 7, FIG. 8 plots the charging current received by plug adapter 110 against the temperature measured by thermal sensor 140, consistent with another embodiment.

In addition to first threshold temperature 142 and second threshold temperature 144, processor 113 may be configured to reduce the charging current provided to plug adapter 110 based on intermediate threshold temperatures 146 and 148. If the temperature of plug adapter 110, as measured by thermal sensor 140 exceeds first threshold temperature 142, processor 113 may decrease the charging current from the first level to a second level, and processor 113 may again decrease the charging current to a third level if the temperature measured by thermal sensor 140 exceeds intermediate threshold temperature 146. If the temperature of plug adapter 110, as measured by thermal sensor 140 does not exceed intermediate threshold temperature 148, processor 113 may cause the charging current to remain steady at the third level. If the temperature of plug adapter 110 exceeds intermediate threshold temperature 148, however, processor 113 may cause the charging current to be reduced to a fourth level. Similarly, if the temperature of plug adapter 110 exceeds second threshold temperature 144, processor 113 may turn the charging current off. The use of intermediate temperature thresholds ensures that the charging current is adjusted gradually in response to the temperature increase, in order to find a changing current level that may continue to charge vehicle 116 while keeping the temperature below the hazardous level. As discussed herein, it should be appreciated that in some embodiments more than four threshold temperatures may exist (e.g., 5, 6, 8, or 10).

In some embodiments, processor 113 may decrease the charging current by a fixed amount if any threshold temperature is exceeded. In other embodiments, processor 113 may decrease the charging current by a different amount depending on which threshold temperature has been exceeded. For example, processor 113 may cause the charging current to be decreased by a first amount if threshold temperature 142 is exceeded and may cause the charging current to be decreased by a second amount, greater than the first amount if intermediate threshold temperature 146 is exceeded.

It is contemplated that the charging current does not need to be reduced instantly at each temperature threshold, as shown in FIG. 7 and FIG. 8. Instead, the profile may have any curve shape that continues to decrease as temperature rises. For example, the charging current may decrease linearly, or parabolically.

It is also contemplated that, if after the charging current is reduced the temperature drops, processor 113 may increase the charging current to a higher level. For example, consistent with FIG. 7, if the temperature drops under the first temperature threshold after the charging current is reduced to the lower level, processor 113 may set the charging current back to the first level.

It will be apparent to those skilled in the art that various modifications and variations can be made to the disclosed charging system and related methods. Other embodiments will be apparent to those skilled in the art from consideration of the specification and practice of the disclosed charging system and related methods. It is intended that the specification and examples be considered as exemplary only, with a true scope being indicated by the following claims and their equivalents.

What is claimed is:

1. A charging system comprising:
a plug adapter for receiving a charging current, the plug adapter comprising a thermal sensor configured to measure a temperature associated with the plug adapter; and
a processor configured to receive data from the plug adapter;
wherein the processor is configured to decrease the charging current if the temperature measured by the thermal sensor exceeds a first threshold temperature and wherein the processor is configured to turn off the charging current if the temperature measured by the thermal sensor exceeds a second threshold temperature.

2. The charging system of claim 1, wherein the processor receives data from the plug adapter wirelessly.

3. The charging system of claim 1, wherein the processor receives data from the plug adapter via a cable.

4. The charging system of claim 1, wherein the first threshold temperature is lower than the second threshold temperature.

5. The charging system of claim 1, wherein the thermal sensor measures the temperature at a joint of contacts in the plug adapter.

6. The charging system of claim 1, wherein the processor is configured to generate a maintenance alert if the second threshold temperature is exceeded.

7. The charging system of claim 1, wherein the thermal sensor is a thermistor.

8. The charging system of claim 6, wherein the maintenance alert is sent wirelessly to a user.

9. The charging system of claim 1, wherein the charging current is reduced from a first charging current to a second charging current lower than the first charging current when the first threshold temperature is exceeded.

10. The charging system of claim 9, wherein the first charging current is determined based on a maximum charging current.

11. The charging system of claim 1, wherein the second threshold temperature is about equal to a melting point of the plug adapter.

12. A method of charging comprising:
measuring a temperature associated with a plug adapter for receiving a charging current, the plug adapter comprising a thermal sensor configured to measure the temperature;
providing data comprising the temperature measurement to a processor;
causing, by the processor, the charging current to decrease if the temperature measured by the thermal sensor exceeds a first threshold temperature; and
causing, by the processor, the charging current to turn off if the temperature measured by the thermal sensor exceeds a second threshold temperature.

13. The method of claim 12, wherein the data is wirelessly provided to the processor.

14. The method of claim 12, wherein the data is provided to the processor via a cable.

15. The method of claim 12, wherein the first threshold temperature is lower than the second threshold temperature.

16. The method of claim 12, further comprising the step of generating a maintenance alert if the second threshold temperature is exceeded.

17. The method of claim 12, further comprising an electric vehicle supply equipment (EVSE) connected to the plug adaptor, wherein the EVSE comprises the processor.

18. The method of claim 12, wherein the thermal sensor is a thermistor.

19. The method of claim 12, wherein the second threshold temperature is about equal to a melting point of the plug adapter.

20. A charging system for an electric vehicle comprising:
a plug adapter for receiving a charging current, the plug adapter comprising a thermal sensor configured to measure a temperature associated with the plug adapter; and
an electric vehicle supply equipment (EVSE) comprising a processor, the processor configured to receive data from the plug adapter;
wherein the processor is configured to decrease the charging current if the temperature measured by the thermal sensor exceeds a first threshold temperature and wherein the processor is configured to turn off the charging current if the temperature measured by the thermal sensor exceeds a second threshold temperature.
